(19) United States
(12) Patent Application Publication
(10) Pub. No.: US 2025/0296039 A1
(43) Pub. Date: Sep. 25, 2025

(54) CARBON DIOXIDE RECOVERY APPARATUS

(71) Applicant: HONDA MOTOR CO., LTD., Tokyo (JP)

(72) Inventor: Ryohei IKUTOMO, Saitama (JP)

(21) Appl. No.: 19/063,350

(22) Filed: Feb. 26, 2025

(30) Foreign Application Priority Data
Mar. 25, 2024 (JP) 2024-047774

(51) Int. Cl. B01D 53/34; B01D 53/62; B01D 53/81

(52) U.S. Cl. CPC B01D 53/346; B01D 53/62; B01D 53/81; B01D 2253/106; B01D 2257/504; B01D 2258/06

(57) ABSTRACT

To provide a carbon dioxide recovery apparatus that can suppress deterioration of an adsorbent material therein even in a high ambient air temperature environment. A carbon dioxide recovery apparatus 1 includes: an ambient air temperature sensor that acquires an ambient air temperature at a location where a reactor is disposed; a carbon dioxide sensor that acquires a carbon dioxide concentration in the atmosphere; a humidity sensor that acquires a humidity in the atmosphere; and a flow rate controller that adjusts a flow rate of the gas flowing in the reactor by controlling the fan, an intake valve, and an exhaust valve based on the ambient air temperature, the carbon dioxide concentration, and the humidity so that the temperature of an adsorbent material in an adsorption step of adsorbing carbon dioxide on the adsorbent material does not exceed a preset threshold.

This application is based on and claims the benefit of priority from Japanese Patent Application No. 2024-047774, filed on 25 Mar. 2024, the content of which is incorporated herein by reference.

### BACKGROUND OF THE INVENTION

### Field of the Invention

The present invention relates to a carbon dioxide recovery apparatus.

### Related Art

There are known conventional technologies for recovering carbon dioxide from gases, such as ambient air, that contain carbon dioxide. For example, Japanese Unexamined Patent Application (Translation of PCT Application), Publication No. 2017-528318 discloses one of such technologies. Japanese Unexamined Patent Application (Translation of PCT Application), Publication No. 2017-528318 discloses a method for separating gaseous carbon dioxide from a gas mixture by cyclic adsorption/desorption using a sorbent material that adsorbs the gaseous carbon dioxide.

Patent Document 1: Japanese Unexamined Patent Application (Translation of PCT Application), Publication No. 2017-528318

### SUMMARY OF THE INVENTION

In an adsorption step of adsorbing carbon dioxide on an adsorbent material, the temperature of the adsorbent material rises due to adsorption heat generated when carbon dioxide and water are adsorbed. In a high ambient air temperature environment, the base temperature of the adsorbent material is high, and consequently the temperature of the adsorbent material reaches a higher temperature (for example, 50° C.) when the adsorption heat is generated. As a result, the adsorbent material becomes prone to oxidation and deterioration.

An object of the present invention is to provide a carbon dioxide recovery apparatus that can suppress deterioration of an adsorbent material therein even in a high ambient air temperature environment.

(1) The present invention provides a carbon dioxide recovery apparatus (for example, a carbon dioxide recovery apparatus 1 described below) including: a reactor (for example, a reactor 11 or reactors 11a to 11c described below) containing an adsorbent material (for example, an adsorbent material 12 described below); an intake line (for example, an intake line 101 or an intake line 101a described below) that is connected to an upstream side of the reactor and through which gas containing carbon dioxide flows and passes; an airflow regulator (for example, a fan 61, an intake valve 21, and an exhaust valve 31 described below) adapted to adjust a flow rate of the gas to be supplied from the intake line to the adsorbent material in the reactor; an ambient air temperature detector (for example, an ambient air temperature sensor 52 described below) that acquires an ambient air temperature at a location where the reactor is disposed; a carbon dioxide concentration detector (for example, a carbon dioxide sensor 53 described below) that acquires a carbon dioxide concentration in the atmosphere; a humidity detector (for example, a humidity sensor 54 described below) that acquires a humidity in the atmosphere; and a flow rate controller (for example, a flow rate controller 56 described below) that adjusts a flow rate of the gas flowing in the reactor by controlling the airflow regulator based on the ambient air temperature, the carbon dioxide concentration, and the humidity so that the temperature of the adsorbent material in an adsorption step of adsorbing carbon dioxide on the adsorbent material does not exceed a preset threshold (for example, an oxidation limit temperature described below).

(2) The carbon dioxide recovery apparatus described in (1) may further include a temperature calculator (for example, a controller 55 described below) that calculates a predicted temperature of the adsorbent material in a case where the adsorption step is executed based on the ambient air temperature, the carbon dioxide concentration, and the humidity. In this carbon dioxide recovery apparatus, the flow rate controller may control the flow rate of the gas to a flow rate (for example, a restriction flow rate described below) lower than a preset flow rate so that the temperature of the adsorbent material is kept below the threshold based on the predicted temperature calculated by the temperature calculator.

(3) In the carbon dioxide recovery apparatus described in (2), the flow rate controller may control the flow rate of the gas to the preset flow rate (for example, a normal value of the flow rate described below) after having controlled the flow rate of the gas to the flow rate lower than the preset flow rate.

(4) In the carbon dioxide recovery apparatus described in any one of (1) to (3), the airflow regulator may include a fan (for example, the fan 61 described below) that generates airflow for feeding the gas into the reactor, and the flow rate controller may control the flow rate of the gas flowing in the reactor by adjusting an amount of airflow to be generated by the fan.

(5) In the carbon dioxide recovery apparatus described in any one of (1) to (3), the airflow regulator may include an intake valve (for example, the intake valve 21 described below) disposed on the upstream side of the reactor and configured to adjust the flow rate, and an exhaust valve (for example, the exhaust valve 31 described below) disposed on a downstream side of the reactor and configured to adjust the flow rate, and the flow rate controller may control the flow rate of the gas flowing in the reactor by adjusting a degree of opening of the intake valve and a degree of opening of the exhaust valve.

(6) The carbon dioxide recovery apparatus described in any one of (1) to (3) may include a plurality of the reactors (for example, the reactors 11a to 11c described below). In this carbon dioxide recovery apparatus, the flow rate controller may be adapted to control the flow rate of the gas for the respective reactors at different timings.

According to the present invention, it is possible to provide a carbon dioxide recovery apparatus that can suppress deterioration of an adsorbent material therein even in a high ambient air temperature environment.

### BRIEF DESCRIPTION OF THE DRAWINGS

FIG. 1 is a schematic diagram illustrating a configuration of a carbon dioxide recovery apparatus according to an embodiment of the present invention;

FIG. 2 is a graph for explaining temperature rise of an adsorbent material due to generation of adsorption heat;

FIG. 3 is a graph indicating the relationship between the ambient air temperature and the temperature of the adsorbent material, which changes depending on the ambient air temperature;

FIGS. 4A and 4B are each a graph for explaining flow rate control reflecting the ambient air temperature; and

FIG. 5 is a schematic diagram illustrating a configuration of a carbon dioxide recovery apparatus according to a modification example.

### DETAILED DESCRIPTION OF THE INVENTION

The following describes an embodiment of the present invention with reference to the drawings.

### Overall Configuration

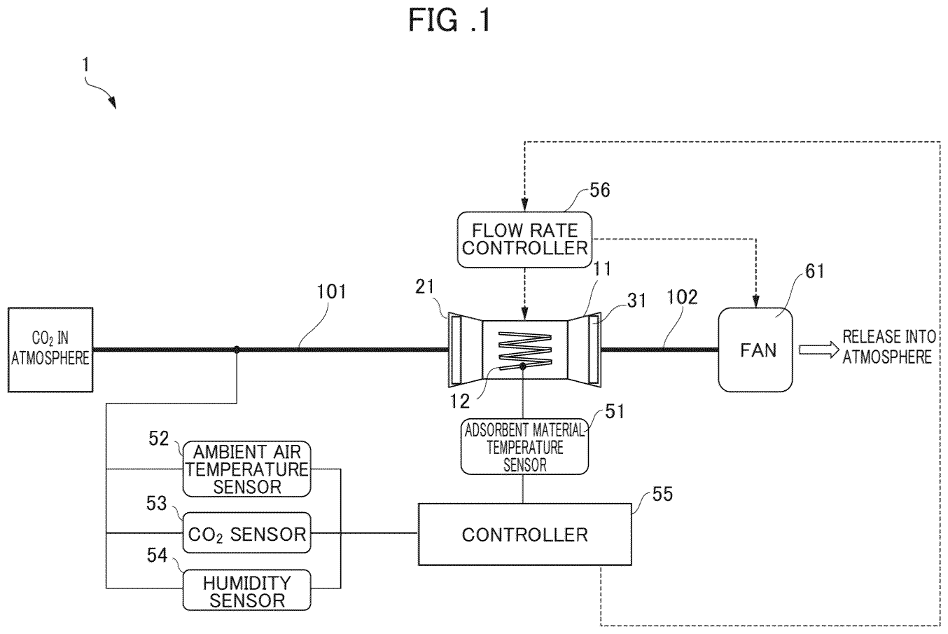

FIG. 1 is a schematic diagram illustrating a configuration of a carbon dioxide recovery apparatus 1 according to an embodiment of the present invention. The carbon dioxide recovery apparatus 1 is, for example, applied to direct air capture (DAC) technology for recovering carbon dioxide from ambient air in order to reduce the carbon dioxide concentration in the ambient air. Carbon dioxide recovered using the carbon dioxide recovery apparatus 1 is stored underground or reused as fuel or material.

As shown in FIG. 1, the carbon dioxide recovery apparatus 1 includes an intake line 101, a reactor 11, an exhaust line 102, a fan 61, an adsorbent material temperature sensor 51, an ambient air temperature sensor 52, a carbon dioxide sensor 53, a humidity sensor 54, a controller 55, and a flow rate controller 56.

The intake line 101 is a pipe located upstream of the reactor 11 and serves as a flow path for feeding ambient air into the reactor 11.

The exhaust line 102 is a pipe connected to a downstream side of the reactor 11 and serves as a flow path for exhausting gas that has passed through an adsorbent material 12 in the reactor 11 to the outside.

The reactor 11 contains the adsorbent material 12 for adsorbing carbon dioxide. The adsorbent material 12 is a particulate material and has the following properties. That is, the adsorbent material 12 adsorbs carbon dioxide at low temperatures (for example, in the range of −30° C. to 50° C.), and desorbs (releases) carbon dioxide at high temperatures (for example, in the range of 50°° C. to 110°° C.) and at low ambient carbon dioxide concentrations. Examples of adsorbent materials usable as the adsorbent material 12 include a solid amine carbon dioxide adsorbent material composed of a porous material such as silica and amine supported on the porous material. The reactor 11 alternates between an adsorption step of adsorbing carbon dioxide in ambient air or other gas drawn into the reactor 11 on the adsorbent material 12 and a desorption step of desorbing the carbon dioxide adsorbed on the adsorbent material 12 by creating a vacuum, and then performing heating under reduced pressure.

The reactor 11 according to the present embodiment includes an intake valve 21 disposed in a position of connection with the intake line 101 and an exhaust valve 31 disposed in a position of connection with the exhaust line 102. The intake valve 21 and the exhaust valve 31 are, for example, a flow rate regulator capable of adjusting the flow rate of gas that enters the reactor 11 from an intake port of the reactor 11 and then is exhausted from an exhaust port to the outside by changing the degree of opening (area of opening) of each port.

The fan 61 is located downstream of the reactor 11 and disposed on a downstream side of the exhaust line 102. The fan 61 is a flow rate regulator capable of adjusting the flow rate of gas that enters the reactor 11 from the intake port of the reactor 11 and then is exhausted from the exhaust port to the outside by changing the amount of airflow to be generated by the fan 61. The fan 61 is driven to produce, through the exhaust line 102, a flow of gas from an “intake end” to an “exhaust end” for the reactor 11. Thus, gas is introduced from the atmosphere into the reactor 11 through the intake line 101, passes through the adsorbent material 12, and then is exhausted into the ambient air through the exhaust line 102. The air exhausted through the exhaust line 102 has a higher percentage of nitrogen and oxygen as a result of the carbon dioxide being recovered.

The adsorbent material temperature sensor 51 is an adsorbent material temperature detector that detects the temperature of the adsorbent material 12 in the reactor 11. Information indicating the temperature detected by the adsorbent material temperature sensor 51 is outputted to the controller 55. The temperature of the adsorbent material is used, for example, to trigger transition from one step to another or to detect that the temperature of the adsorbent material 12 has reached an abnormal level.

The ambient air temperature sensor 52 is an ambient air temperature detector that detects the ambient air temperature at a location where the reactor 11 performs the adsorption step. The ambient air temperature detected by the ambient air temperature sensor 52 is outputted to the controller 55. The ambient air temperature is used as a base temperature to predict the temperature of the adsorbent material 12 in the adsorption step.

The carbon dioxide sensor 53 is a carbon dioxide concentration detector that detects the carbon dioxide concentration at the location where the reactor 11 performs the adsorption step. Information indicating the carbon dioxide concentration detected by the carbon dioxide sensor 53 is outputted to the controller 55. The carbon dioxide concentration in the atmosphere is used to reflect, in calculation of the predicted temperature of the adsorbent material 12, the adsorption heat that results from the adsorption of carbon dioxide on the adsorbent material 12 in the adsorption step.

The humidity sensor 54 is a humidity detector that detects the humidity at the location where the reactor 11 performs the adsorption step. Information indicating the humidity detected by the humidity sensor 54 is outputted to the controller 55. The humidity in the atmosphere is used to reflect, in the calculation of the predicted temperature of the adsorbent material 12, the adsorption heat that results from the adsorption of water on the adsorbent material 12 in the adsorption step.

The controller 55 and the flow rate controller 56 perform flow rate control to adjust the flow rate of the gas to be supplied to the reactor 11 so as to prevent the adsorbent material 12 from reaching a temperature where the adsorbent material 12 is easily oxidized in the adsorption step. The controller 55 and the flow rate controller 56 are implemented using a computer having, for example, a central processing unit (CPU), read only memory (ROM), and random access memory (RAM). Furthermore, the controller 55 and the flow rate controller 56 may be implemented, for example, using electronic components of electrical circuits, such as relays. The controller 55 and the flow rate controller 56 may be independent of each other or may be incorporated into a single computer.

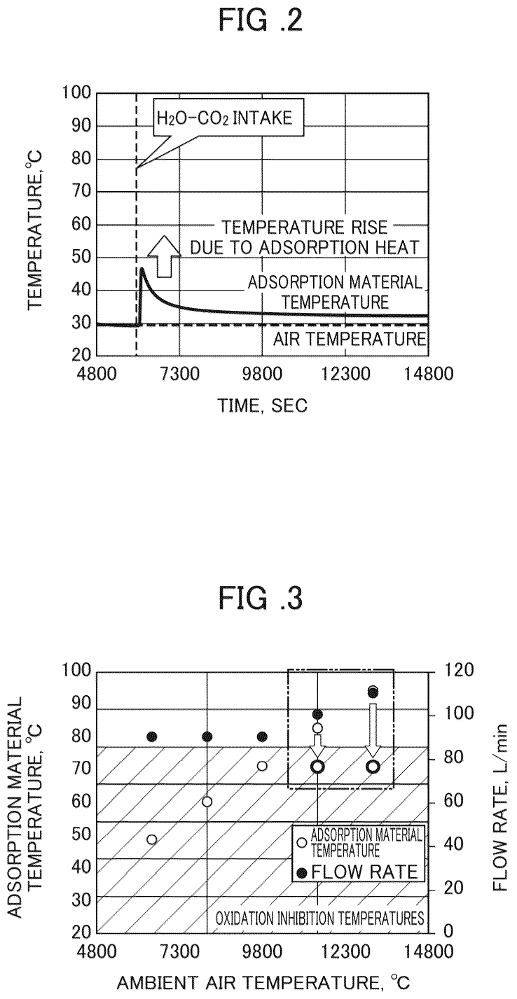

Environmental conditions such as the ambient air temperature, the carbon dioxide concentration in the atmosphere, and the humidity in the atmosphere are reflected in the flow rate control by the controller 55 and the flow rate controller 56. Referring now to FIGS. 2 and 3, the following describes the relationship between the temperature of the adsorbent material 12 and the ambient air temperature. FIG. 2 is a graph for explaining the temperature rise of the adsorbent material 12 due to the generation of the adsorption heat. The vertical axis of the graph shown in FIG. 2 represents the temperature (° C.) and the horizontal axis represents the elapsed time (sec) in the adsorption step. The graph shown in FIG. 2 indicates that the temperature of the adsorbent material 12 significantly rises immediately after the adsorption step begins due to the adsorption heat generated when carbon dioxide and water are adsorbed on the adsorbent material 12, and that the temperature gradually decreases thereafter with the passage of time. In this example, the ambient air temperature is approximately 30° C. Thus, the temperature of the adsorbent material 12 does not reach 50° C., where the adsorbent material 12 is easily oxidized, despite the generation of the adsorption heat.

FIG. 3 is a graph indicating the relationship between the ambient air temperature and the temperature of the adsorbent material 12, which changes depending on the ambient air temperature. The left vertical axis of the graph shown in FIG. 3 represents the temperature of the adsorbent material 12, the horizontal axis represents the ambient air temperature, and the right vertical axis represents the flow rate (L/min) of the gas flowing in the reactor 11. As can be seen from the graph shown in FIG. 3, the temperature of the adsorbent material 12 reaches and exceeds 50° C., exceeding an oxidation inhibition temperature range, as the ambient air temperature reaches and exceeds 40° C. Exceeding the oxidation inhibition temperature range, the adsorbent material 12 is easily oxidized. In order to suppress degradation, it is preferable that the temperature of the adsorbent material 12 be lowered to be kept within the oxidation inhibition temperature range even if the ambient air temperature is 40° C. or higher. One possible way of lowering the temperature of the adsorbent material 12 to within the oxidation inhibition temperature range in the adsorption step is by reducing the flow rate, which in turn reduces the adsorption amount. There is room to reduce the flow rate because the flow rate set with respect to ambient air having a temperature of 40°° C. or higher is high enough.

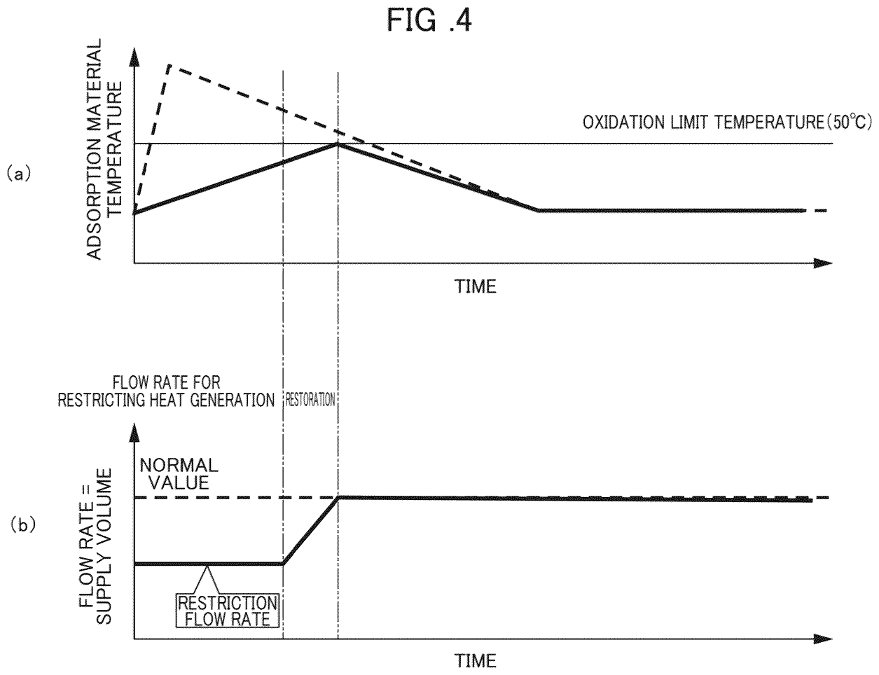

Referring to FIGS. 4A and 4B, the following describes the flow rate control by the controller 55 and the flow rate controller 56. FIGS. 4A and 4B are each a graph for explaining the flow rate control reflecting the ambient air temperature. FIG. 4A is a graph showing an example of the temporal change in the predicted temperature of the adsorbent material as calculated by the controller 55. FIG. 4B is a graph showing an example of the temporal change in the flow rate as adjusted by the flow rate controller 56. The vertical axis of FIG. 4A represents the temperature of the adsorbent material 12, and the horizontal axis represents the elapsed time in the adsorption step. The vertical axis of FIG. 4B represents the flow rate (supply volume) of the gas flowing in the reactor 11, and the horizontal axis represents the elapsed time in the adsorption step.

A dashed line in FIG. 4A indicates the change in the temperature of the adsorbent material 12 in a case where the flow rate control is not performed and the adsorption step is executed at a constant flow rate in a high ambient air temperature environment. As indicated by the dashed line, in a case where the flow rate is not changed and the adsorption step is executed at a constant flow rate in a high ambient air temperature environment, the temperature of the adsorbent material 12 can exceed an oxidation limit temperature (50° C.), which is a threshold of the oxidation inhibition range, in the early stage of the adsorption step.

The controller 55 calculates the predicted temperature of the adsorbent material 12 in the adsorption step based on the ambient air temperature, the carbon dioxide concentration, and the humidity. The ambient air temperature is a parameter related to the base temperature of the adsorbent material 12. The carbon dioxide concentration in the atmosphere affects the amount of carbon dioxide to be adsorbed on the adsorbent material 12 and is a parameter related to the adsorption heat that results from the carbon dioxide adsorption. The humidity in the atmosphere affects the amount of water to be adsorbed on the adsorbent material 12 and is a parameter related to the adsorption heat that results from the water adsorption.

The controller 55 can calculate the predicted temperature of the adsorbent material 12 using, for example, a formula theoretically or empirically derived based on learning data or an experimental model from the past operational results of the carbon dioxide recovery apparatus 1, a table, or a learning model built through machine learning. The controller 55 outputs the thus calculated predicted temperature to the flow rate controller 56 as a required value for the flow rate control.

The flow rate controller 56 performs the flow rate control to adjust the flow rate of the gas flowing in the reactor 11 in the adsorption step based on the predicted temperature of the adsorbent material 12 (required value) inputted from the controller 55. As indicated by a solid line in the graph shown in FIG. 4A, the flow rate of the gas passing through the interior of the reactor 11 is adjusted by the flow rate controller 56 so that the temperature of the adsorbent material 12 does not exceed the oxidation limit temperature (50° C.).

As shown in FIG. 4B, in the flow rate controller 56, a normal value is set as a flow rate that is applied in the case of an ordinary temperature environment where the temperature of the adsorbent material 12 does not exceed the oxidation limit temperature even if the adsorption heat is generated. As long as the temperature of the adsorbent material 12 does not exceed the oxidation limit temperature, the adsorption step is carried out at a constant flow rate (normal value).

If the result of the calculation of the predicted temperature by the controller 55 indicates that the temperature of the adsorbent material 12 exceeds the oxidation limit temperature, the flow rate controller 56 controls the flow rate so that the temperature of the adsorbent material 12 does not exceed the oxidation limit temperature. In the example shown in FIG. 4B, the flow rate controller 56 performs control to reduce the flow rate to a restriction flow rate lower than the normal value in the early stage of the adsorption step, in which the temperature of the adsorbent material 12 is likely to be high. As a result, the temperature of the adsorbent material 12 stays below the oxidation limit temperature, as indicated by the solid line in the graph shown in FIG. 4A.

The flow rate controller 56 that has reduced the flow rate to below the normal value performs control to restore the flow rate to the normal value after a certain period of time. The restriction flow rate and a restoration time can be calculated using, for example, a formula theoretically or empirically derived based on learning data or an experimental model from the past operational results of the carbon dioxide recovery apparatus 1, a table, or a learning model built through machine learning. The restoration time is information for determining a slope at which the flow rate is restored from the restriction flow rate to the normal value. The restriction flow rate and the restoration time may be set by reflecting the effects of the ambient air temperature, the carbon dioxide concentration, and the humidity on a preset reference flow rate and a preset restoration time.

The flow rate controller 56 of the present embodiment adjusts the flow rate by changing the amount of airflow to be generated by the fan 61 according to the set flow rate. The flow rate controller 56 may adjust the flow rate by changing the degree of opening of the intake valve 21 and the degree of opening of the exhaust valve 31 as well as the amount of airflow to be generated by the fan 61. In this case, the flow rate controller 56 may adjust the flow rate by adjusting the degree of opening of the intake valve 21 and the degree of opening of the exhaust valve 31 while keeping the amount of airflow to be generated by the fan 61 constant. After completion of the adsorption step, the desorption step is executed, so that the carbon dioxide adsorbed on the adsorbent material 12 is recovered.

As described above, the carbon dioxide recovery apparatus 1 according to the present embodiment includes: a reactor 11 containing an adsorbent material 12; an intake line 101 that is connected to an upstream side of the reactor 11 and through which gas containing carbon dioxide flows and passes; a fan 61, an intake valve 21, and an exhaust valve 31 (airflow regulator) adapted to adjust the flow rate of the gas to be supplied from the intake line 101 to the adsorbent material 12 in the reactor 11; an ambient air temperature sensor (ambient air temperature detector) 52 that acquires the ambient air temperature at a location where the reactor 11 is disposed; a carbon dioxide sensor (carbon dioxide concentration detector) 53 that acquires the carbon dioxide concentration in the atmosphere; a humidity sensor (humidity detector) 54 that acquires the humidity in the atmosphere; and a flow rate controller 56 that adjusts the flow rate of the gas flowing in the reactor 11 by controlling the fan 61, the intake valve 21, and the exhaust valve 31 based on the ambient air temperature, the carbon dioxide concentration, and the humidity so that the temperature of the adsorbent material 12 in an adsorption step of adsorbing carbon dioxide on the adsorbent material 12 does not exceed a preset oxidation limit temperature (threshold).

This configuration makes it possible to reduce the flow rate of the gas to be fed to the adsorbent material 12 in a situation where the ambient air temperature, the carbon dioxide concentration in the atmosphere, and the humidity in the atmosphere are those that lead to generation of a significant amount of adsorption heat. As a result of the flow rate being reduced, the amount of carbon dioxide and water to be fed to the adsorbent material 12 decreases to a relatively small level, and the adsorption heat to be generated through an adsorption reaction also decreases. Thus, it is possible to prevent the temperature of the adsorbent material 12 from exceeding the oxidation limit temperature in the adsorption step. Furthermore, the amount of oxygen contained in the gas to be fed to the adsorbent material 12 decreases with the decrease in the flow rate, making it less likely for oxidation to occur, which causes deterioration of the adsorbent material 12. The carbon dioxide recovery apparatus 1 according to the present embodiment makes it possible to ensure a longer lifetime of the adsorbent material 12 without the need for an additional complex device configuration.

The carbon dioxide recovery apparatus 1 according to the present embodiment further includes a controller (temperature calculator) 55 that calculates a predicted temperature of the adsorbent material 12 in a case where the adsorption step is executed based on the ambient air temperature, the carbon dioxide concentration, and the humidity. In this carbon dioxide recovery apparatus 1, the flow rate controller 56 controls the flow rate of the gas to a flow rate lower than a preset flow rate so that the temperature of the adsorbent material 12 is kept below the threshold based on the predicted temperature calculated by the controller 55.

This configuration makes it possible to appropriately set the flow rate that allows the temperature of the adsorbent material 12 to be kept below the oxidation limit temperature, based on the predicted temperature of the adsorbent material 12 calculated based on the ambient air temperature, the carbon dioxide concentration, and the humidity. Thus, it is possible to suppress deterioration of the adsorbent material 12 more reliably.

In the present embodiment, the flow rate controller 56 controls the flow rate of the gas to the preset flow rate (normal value of the flow rate) after having controlled the flow rate of the gas to the flow rate (restriction flow rate) lower than the preset flow rate.

This configuration makes it possible to reduce the flow rate in the early stage of the adsorption step, in which the temperature of the adsorbent material 12 is likely to be high, and to increase the flow rate in the middle or later stage, in which the temperature decreases with the passage of time, increasing the amount of carbon dioxide to be adsorbed. That is, this configuration makes it possible to minimize reduction in carbon dioxide recovery rate due to the reduction of the flow rate while achieving suppression of deterioration of the adsorbent material 12.

In the present embodiment, the airflow regulator includes the fan 61 that generates airflow for feeding the gas into the reactor 11, and the flow rate controller 56 controls the flow rate of the gas flowing in the reactor 11 by adjusting the amount of airflow to be generated by the fan 61.

This configuration makes it possible to control the flow rate so that the temperature of the adsorbent material 12 does not exceed the oxidation limit temperature in the adsorption step even in a high ambient air temperature environment, by adjusting the rotational speed of the fan 61 that generates airflow for feeding the gas to the adsorbent material 12 in the reactor 11.

In the present embodiment, the airflow regulator includes the intake valve 21 disposed on the upstream side of the reactor 11 and configured to adjust the flow rate, and the exhaust valve 31 disposed on the downstream side of the reactor 11 and configured to adjust the flow rate, and the flow rate controller 56 may control the flow rate of the gas flowing in the reactor 11 by adjusting the degree of opening of the intake valve 21 and the degree of opening of the exhaust valve 31.

This configuration makes it possible to control the flow rate so that the temperature of the adsorbent material 12 does not exceed the oxidation limit temperature in the adsorption step even in a high ambient air temperature environment, through adjustment of the areas of opening of an inlet and an outlet of the reactor 11 by changing the degree of opening of the intake valve 21 and the degree of opening of the exhaust valve 31.

Although an example of a single-reactor configuration in which carbon dioxide is recovered using a single reactor 11 retaining the adsorbent material 12 has been described above, the present invention can also be applied to a carbon dioxide recovery apparatus having a configuration in which a plurality of reactors 11 perform the adsorption step and the desorption step in parallel.

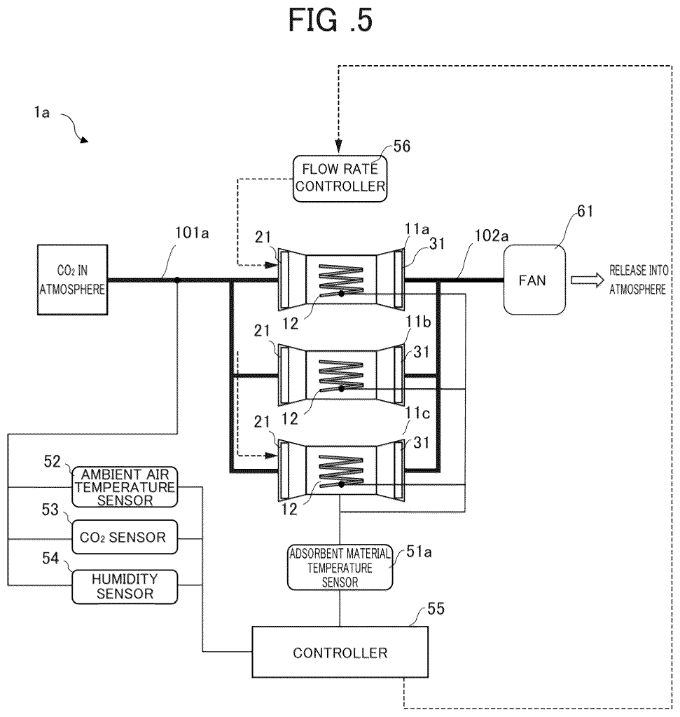

Referring now to FIG. 5, the following describes an example of a carbon dioxide recovery apparatus la including a plurality of reactors 11a, 11b, and 11c. FIG. 5 is a schematic diagram illustrating a configuration of the carbon dioxide recovery apparatus la according to a modification example. In the following description, the same or similar elements of configuration as those in the foregoing embodiment are labelled using the same reference numerals as in the foregoing embodiment, and detailed description thereof may be omitted.

An intake line 101a of the carbon dioxide recovery apparatus la according to the modification example is split into branch sections that are respectively connected to the plurality of reactors 11a, 11b, and 11c. Likewise, an exhaust line 102a is split into branch sections that are respectively connected to downstream sides of the plurality of reactors 11a, 11b, and 11c. The fan 61 is disposed on a non-branch section of the exhaust line 102a, so that airflow can be generated for feeding ambient air into each of the plurality of reactors 11a, 11b, and 11c by driving the fan 61.

Each of the plurality of reactors 11a, 11b, and 11c is provided with an intake valve 21 and an exhaust valve 31, which can be independently controlled on a per-reactor 11 basis. Thus, for example, the reactor 11c can perform the desorption step while the reactor 11a and the reactor 11b are performing the adsorption step. This configuration allows the flow rate controller 56 to control the flow rate so that the temperature of the adsorbent material 12 does not exceed the oxidation limit temperature while different steps are performed in parallel.

As described above, according to the modification example, the carbon dioxide recovery apparatus la includes the plurality of reactors 11a to 11c, and the flow rate controller 56 is capable of controlling the flow rate of the gas for the respective reactors 11a to 11c at different timings.

Since the plurality of reactors 11a to 11c perform the adsorption step and the desorption step in parallel while the flow rate is controlled so that the temperature of the adsorbent material 12 is kept below the oxidation limit temperature in the adsorption step, this configuration makes it possible to distribute the load on the device.

Although only three reactors 11a, 11b, and 11c are shown in FIG. 5, the carbon dioxide recovery apparatus la according to the modification example may have a configuration including more than three reactors 11.

Although an embodiment of the present invention has been described above, the present invention is not limited to the foregoing embodiment. The effects described in the foregoing embodiment are mentioned just as preferable effects of the present invention. Effects to be produced by the present invention are not limited to those described in the foregoing embodiment.

For example, the carbon dioxide recovery apparatus may have a configuration in which the controller 55 includes an alarm light for informing an operator that the temperature of the adsorbent material 12 is predicted to exceed the oxidation limit temperature in the adsorption step.

For another example, the controller 55 may use the temperature of the adsorbent material 12 detected by the adsorbent material temperature sensor 51 in temperature prediction.

### EXPLANATION OF REFERENCE NUMERALS

1: Carbon dioxide recovery apparatus
11, 11a, 11b, 11c: Reactor
12: Adsorbent material
21: Intake valve
31: Exhaust valve
52: Ambient air temperature sensor
53: Carbon dioxide sensor
54: Humidity sensor
55: Controller
56: Flow rate controller
61: Fan
101, 101a: Intake line
102, 102a: Exhaust line

What is claimed is:

1. A carbon dioxide recovery apparatus comprising:
a reactor containing an adsorbent material;
an intake line that is connected to an upstream side of the reactor and through which gas containing carbon dioxide flows and passes;
an airflow regulator adapted to adjust a flow rate of the gas to be supplied from the intake line to the adsorbent material in the reactor;
an ambient air temperature detector that acquires an ambient air temperature at a location where the reactor is disposed;
a carbon dioxide concentration detector that acquires a carbon dioxide concentration in the atmosphere;
a humidity detector that acquires a humidity in the atmosphere; and
a flow rate controller that adjusts a flow rate of the gas flowing in the reactor by controlling the airflow regulator based on the ambient air temperature, the carbon dioxide concentration, and the humidity so that the temperature of the adsorbent material in an adsorption step of adsorbing carbon dioxide on the adsorbent material does not exceed a preset threshold.

2. The carbon dioxide recovery apparatus according to claim 1, further comprising a temperature calculator that calculates a predicted temperature of the adsorbent material in a case where the adsorption step is executed based on the ambient air temperature, the carbon dioxide concentration, and the humidity, wherein the flow rate controller controls the flow rate of the gas to a flow rate lower than a preset flow rate so that the temperature of the adsorbent material is kept below the threshold based on the predicted temperature calculated by the temperature calculator.

3. The carbon dioxide recovery apparatus according to claim 2, wherein the flow rate controller controls the flow rate of the gas to the preset flow rate after having controlled the flow rate of the gas to the flow rate lower than the preset flow rate.

4. The carbon dioxide recovery apparatus according to claim 1, wherein
the airflow regulator includes a fan that generates airflow for feeding the gas into the reactor, and
the flow rate controller controls the flow rate of the gas flowing in the reactor by adjusting an amount of airflow to be generated by the fan.

5. The carbon dioxide recovery apparatus according to claim 1, wherein
the airflow regulator includes
an intake valve disposed on the upstream side of the reactor and configured to adjust the flow rate, and
an exhaust valve disposed on a downstream side of the reactor and configured to adjust the flow rate, and
the flow rate controller controls the flow rate of the gas flowing in the reactor by adjusting a degree of opening of the intake valve and a degree of opening of the exhaust valve.

6. The carbon dioxide recovery apparatus according to claim 1, comprising a plurality of the reactors, wherein the flow rate controller is adapted to control the flow rate of the gas for the respective reactors at different timings.
